(19) United States
(12) Patent Application Publication
(10) Pub. No.: US 2007/0029867 A1
(43) Pub. Date: Feb. 8, 2007

(54) Tubeless wire spoked wheel

(76) Inventor: Kevin Drage, Fulham (AU)

Correspondence Address: NATH & ASSOCIATES, 112 South West Street, Alexandria, VA, 22314, US

(21) Appl. No.: 10/576,133

(22) PCT Filed: Oct. 15, 2004
(86) PCT No.: PCT/AU04/01414

§ 371 Date: Jul. 12, 2006

(30) Foreign Application Priority Data
Oct. 17, 2003 (AU) 2003905704

(51) Int. Cl. B60B 21/06

(52) U.S. Cl. 301/58

(57) ABSTRACT

Wire spoked tubeless wheel (1) is sealed and made airtight by forming the wheel rim well with a flat base (55) with countersunk holes (40) in the base to fully receive the spoke nipples (45) and applying sealing tape (60) to the flat base covering the countersunk holes (40).

The present invention relates to a tubeless wire spoked (laced) wheel.

Wire spoked wheels generally have a rim upon which a pneumatic tyre is mounted, and a hub connected to the rim of the wheel via an array of spokes.

### BACKGROUND OF THE INVENTION

The tyres employed on wire-spoked wheels generally require an inflatable inner tube, in order to create a properly sealed, air-tight chamber. This is due to the fact that the spokes typically connect to the rim by projecting through a plurality of holes in the rim of the wheel, such that without an inner tube, the holes in the rim would permit the leakage of air there through.

The advantage of using tubeless tyres over conventional tubed tyres, include reduced weight and rolling resistance. As such, numerous attempts have been made to produce a tubeless spoked wheel. One of the best known methods involves applying a sealing means, which is typically an impervious, self adhesive tape, over the spoke nipples in the rim well. There are numerous problems associated with this technique however. Firstly, the nipple heads protrude above the well floor of almost all conventional spoked (laced) wheels. Secondly, the well floor of some conventional spoked wheels, have a concave curve to them. These two factors combine to create a rim well floor surface that is extremely irregular, and the inventor has yet to find non-permeable self adhesive tape that can seal such a surface and withstand inflation pressures.

From time to time, it is necessary to adjust the tensions of the spokes; for instance, when a spoke has become loose, or the wheel has become buckled. Spokes are generally tensioned by using a nipple wrench to rotate a threaded nipple. In conventional wheels however the impervious, self adhesive tape, is placed over the spoke nipples such that the tape is in direct contact with the nipple. Any attempt to rotate the nipple using a nipple wrench therefore, is likely to damage the tape and the seal, allowing the tyre to leak. A significant advantage of the tubeless spoked wheel according to the preferred embodiment, therefore, is that the spoke nipples can be adjusted (rotated) without affecting the airtight seal.

To adjust the spokes of a prior art wheel it would be necessary to remove the tyre, remove the sealing tape, adjust the respective spokes by turning the respective nipples, apply new tape over the nipples and replace and re-inflate the tyre.

It is an object of the present invention to provide a tubeless wire spoked wheel that overcomes or at least substantially ameliorates the problems associated with the tubeless wire wheels of the prior art.

Other objects and advantages of the present invention Will become apparent from the following description, taken in connection with the accompanying drawings, wherein, by way of illustration and example, an embodiment of the present invention is disclosed.

### BRIEF DESCRIPTION OF THE INVENTION

Thus there is provided according to one form of the invention a tubeless wire spoked wheel assembly comprising a wheel rim, a hub and a plurality of spokes connecting the hub to the rim through holes in the bottom of the rim tyre well, the rim having a substantially flat circumferential surface in the bottom of the rim tyre well, the bottom surface of tyre well is recessed around each hole whereby each spoke nipple is completely recessed relative to the flat surface, such that a hermetic sealing means can be applied to the flat surface without interference from the spoke nipple.

In preference, the rim is produced via an extrusion process.

In preference, the rim is extruded from aluminium and/or magnesium.

In preference, the recessed portion is a countersunk hole.

In preference, the sealing means is an impervious, self adhesive tape.

In preference, the planar surface in the bottom of the rim tyre well is substantially flat

In preference, the wheel rim has a relatively constant cross section.

In a further form of the invention, the rim of the wheel may be produced by a casting process.

In preference, the rim is cast from aluminium and/or magnesium.

A significant advantage of the tubeless spoked wheel according to the preferred embodiment, therefore, is that the spoke nipples can be adjusted (rotated) without affecting the airtight seal, the nipples not contacting the undersurface of the sealing tape.

### BRIEF DESCRIPTION OF THE DRAWINGS

For a better understanding of this invention it will now be described with respect to the preferred embodiment which shall be described herein with the assistance of drawings wherein:

FIG. 1 is a perspective, partial cross-sectional view of the tubeless wire spoked wheel according to the preferred embodiment of the present invention; and

FIG. 2 is a detail cross-sectional view of the tubeless wire spoked wheel as shown in FIG. 1; and

FIG. 3 is a detailed cross-sectional view of a conventional wire spoked rim and wheel assembly, as would be used on a motorcycle.

### DESCRIPTION OF THE PREFERRED EMBODIMENT

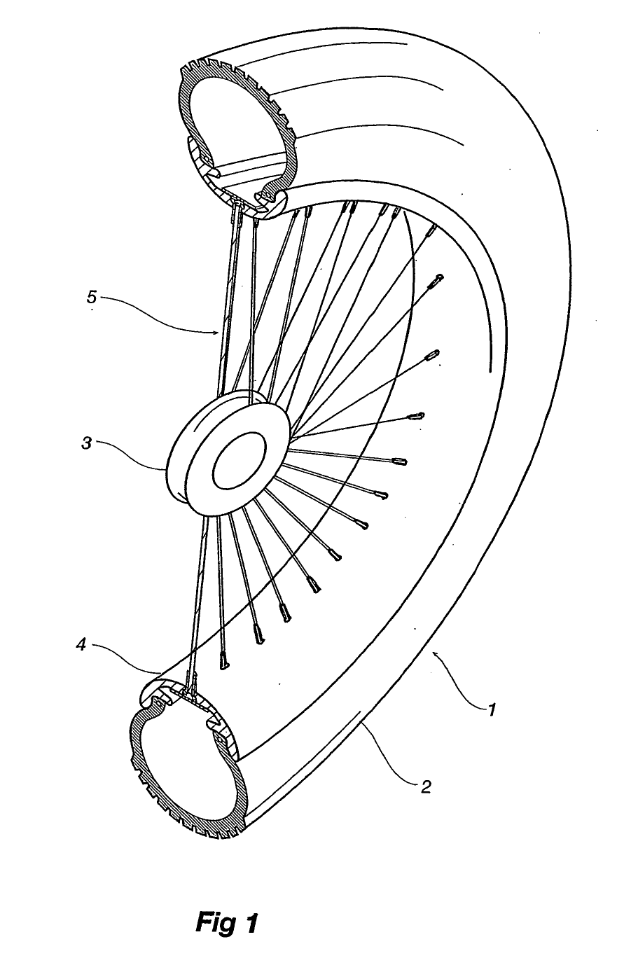

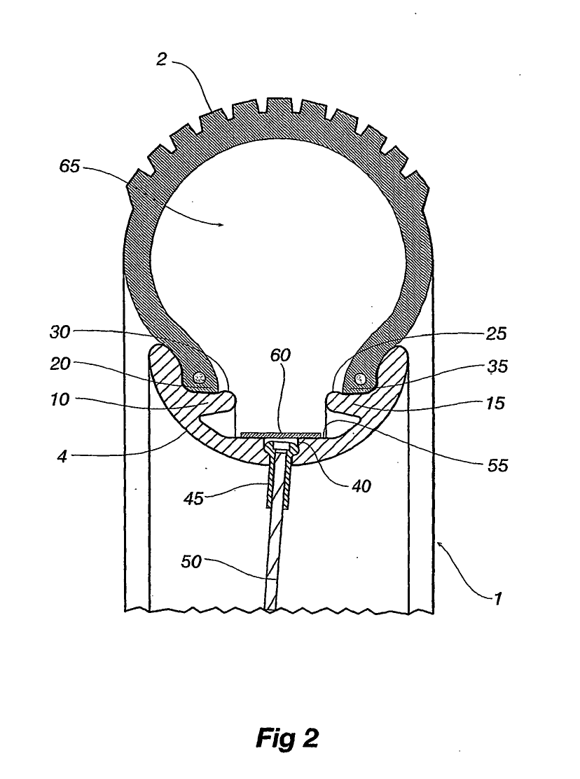

Now referring in particular to FIGS. 1 and 2, a wheel and tyre assembly 1, includes a tubeless tyre 2, a hub 3, a rim 4, and an array of spokes 5.

The embodiment of the invention as illustrated herein, is shown in relation to a motorcycle wheel assembly, but it should be appreciated that the invention is not so limited. In fact the invention is equally applicable to any and all applications to which a spoked wheel may be suited, including for instance car and bicycle wheel assemblies.

Referring now to FIG. 2, where it can be seen that the rim 4 is substantially concave in cross-section, and has inwardly projecting annular flanges 10 and 15, having annular beads seats 30 and 35 respectively formed on them, which assist in seating the beads 20, and 25 of the tyre 2.

The rim 4, has a constant cross-section, which lends itself to manufacture by extrusion; but it is conceivable that it could also be produced by a casting process. The rim 4 is manufactured with a sufficient thickness, such that the spoke nipple 45 and its respective spoke 50, can be located in a countersunk hole 40, that passes through the rim. The countersunk holes are drilled on the extruded rim prior to it being rolled and welded to form the circular wheel rim. The wheel rim can be of aluminium alloy or magnesium alloy construction.

The rim 4 also has a substantially flat bottom surface 55 in the bottom of the rim tyre well. As the spoke nipple 45 sits in the countersunk hole 40, the head of the spoke nipple is completely recessed relative to the flat surface 55, and does not interrupt it by protruding at all. An impervious, self adhesive tape 60, can then be applied to the flat bottom surface 55, hermetically sealing the cavity 65, created by the tyre 2 and rim 4. The flat bottom surface 55, defined by the rim lends itself to effective sealing using a tape 60, but it is conceivable that anyone of a number of alternate sealing products could be successfully employed here due to the favourable sealing surface created.

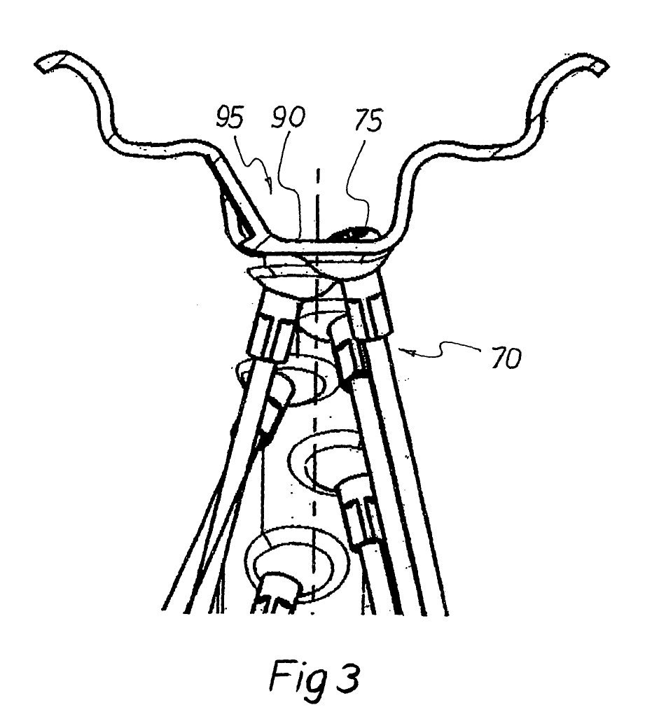

By way of comparison with a conventional wire spoked rim assembly 70 as shown in FIG. 3, the spoke nipples 75 protrude above the floor level 90 of the well 95; making attempts to hermetically seal the spoke nipples problematic.

It is considered that spoked wheels such as those described herein would prove to be of considerable benefit where it is preferable to be able to use a tubeless tyre.

Although the invention has been herein shown and described in what is conceived to be the most practical and preferred embodiment, it is recognised that departures can be made within the scope of the invention, which is not to be limited to the details described herein but is to be accorded the full scope of the appended claims so as to embrace any and all equivalent devices and apparatus.

1. A tubeless wire spoked wheel assembly comprising a wheel rim, a hub and a plurality of spokes connecting the hub to the rim through holes in the bottom of the rim tyre well, the rim having a substantially flat circumferential surface in the bottom of the rim tyre well, the bottom surface of tyre well is recessed around each hole whereby each spoke nipple is completely recessed relative to the flat surface, such that a hermetic seating means can be applied to the flat surface without interference from the spoke nipple.

2. A tubeless wire spoked wheel as defined in claim 1 wherein the recessed portion is a countersunk hole.

3. A tubeless wire spoked wheel as defined in claim 1 wherein the hermetic sealing means is a self adhesive tape.

4. A tubeless wire spoked wheel as defined in claim 2 wherein the wheel rim is extruded, the countersunk holes being drilled prior to rolling and welding the rim in circular shape.

5. A tubeless wire spoked wheel as defined in claim 1 wherein the wheel rim is an aluminium alloy and/or magnesium alloy extrusion.

6. A tubeless wire spoked wheel as defined in claim 1 wherein the rim is cast from aluminium alloy or magnesium alloy.

7. A wheel rim for a tubeless wire spoked wheel, said wheel rim having side walls a bead seat on each side wall, said side walls connected by a flat surfaced bottom of the rim well, and countersunk holes in said flat surfaced bottom to receive spoke nipples, the countersunk portion of the holes being of sufficient depth to fully receive the nipples with no portion of the nipples protruding above the surface of the bottom.

8. A method of sealing a wheel rim of a tubeless wire spoked wheel, said method including the steps of forming a wheel rim having side walls and a base having a flat surface connecting the side walls to form the rim well, forming countersunk holes in the flat surface of the base, locating the spoke nipples in the countersunk holes with the spoke nipples wholly beneath the flat surface, and applying sealing tape to the flat surface to cover the countersunk holes.
